(19) United States
(12) Patent Application Publication
(10) Pub. No.: US 2015/0138021 A1
(43) Pub. Date: May 21, 2015

(54) CAPACITIVE GROUNDING METHODS AND APPARATUS FOR MOBILE DEVICES

(71) Applicant: Pulse Finland Oy, Kempele (FI)

(72) Inventors: Jarmo Konu, Oulu (FI); Prasadh Ramachandran, Oulu (FI); Petteri Annamaa, Oulunsalo (FI)

(21) Appl. No.: 14/085,093

(22) Filed: Nov. 20, 2013

(51) Int. Cl. H01Q 1/48; H01Q 1/24

(52) U.S. Cl. CPC H01Q 1/48; H01Q 1/243
USPC 343/702; 29/825

(57) ABSTRACT

Grounding apparatus for mobile devices and methods of utilizing and manufacturing the same. In one embodiment, an outer metallized surface of a mobile device is configured to capacitively couple a metal back cover to the device ground. Specifically, in one implementation, an exterior surface of the mobile device is metalized and coupled to the device ground via galvanic contacts. The exterior metalized surface is configured to be capacitively coupled a metal back cover of a mobile device to the device ground when the back cover is installed on the mobile device. By capacitively coupling the back cover to the device ground via the exterior metalized surface, the need to otherwise ground the back cover through the use of galvanic contacts is obviated, thereby reducing the number of components needed.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### 1. TECHNOLOGICAL FIELD

The present disclosure relates generally to antenna apparatus for use in electronic devices such as wireless or portable radio devices, and more particularly in one exemplary aspect to space-efficient grounding apparatus and methods of manufacturing and use.

### 2. DESCRIPTION OF RELATED TECHNOLOGY

Internal antennas are commonly found in most modern radio devices, such as mobile computers, tablets, mobile phones, Blackberry® devices, smartphones, personal digital assistants (PDAs), or other personal communication devices (PCD). Typically, these antennas comprise a planar radiating plane and a ground plane parallel thereto, which are connected to each other by a short-circuit conductor in order to achieve the matching of the antenna. The structure is configured so that it functions as a resonator at the desired operating frequency. It is also a common requirement that the antenna operate in more than one frequency band (such as dual-band, tri-band, or quad-band mobile phones), in which case two or more resonators are used.

Recent advances in the development of affordable and power-efficient display technologies for mobile applications (such as liquid crystal displays (LCD), light-emitting diodes (LED) displays, organic light emitting diodes (OLED), thin film transistors (TFT), etc.) have resulted in a proliferation of mobile devices featuring large displays, with screen sizes of up to 180 mm (7 inches) in some tablet computers and up to 500 mm (20 inches) in some laptop computers.

Furthermore, current trends increase the demand for thinner mobile communications devices with large displays that are often used for user input (touch screen). This in turn requires a rigid structure to support the display assembly, particularly during the touch-screen operation, so as to make the interface robust and durable, and mitigate movement or deflection of the display. A metal body or a metal frame is often utilized to provide a better support for the display in the mobile communication device consistent with these requirements.

The use of metal enclosures/chassis and smaller thickness of the device enclosure create new challenges for radio frequency (RF) antenna implementations. Typical antenna solutions (such as monopole, PIFA antennas) require a ground clearance area and sufficient height from the ground plane in order to operate efficiently in multiple frequency bands. These antenna solutions are often inadequate for the aforementioned thin devices with metal housings and/or chassis, as the vertical distance required to separate the radiator from the ground plane is no longer available. Portions of the metal housing may be connected to the device ground through the use of galvanic contacts, and thus factored into the antenna performance. However, the use of numerous galvanic contacts increases material and manufacturing costs, and consumes board space.

Accordingly, there is a salient need for a wireless solution for e.g., a portable radio device with a small form factor metal body and/or chassis that offers a lower cost and complexity, and provides for space-efficient grounding apparatus, and methods of manufacturing and use of the same.

### SUMMARY

The present disclosure satisfies the foregoing needs by providing, inter cilia, space-efficient grounding apparatus and methods of use.

In a first aspect, a mobile wireless device is disclosed. In one embodiment, the mobile wireless device includes: one or more antenna elements, a main body portion that includes a metalized surface, and a back cover portion that is at least partly capacitively coupled to a device ground of the mobile wireless device.

In one variant, the at least metalized surface is connected to the device ground via one or more galvanic contacts.

In another variant, the back cover portion is at least partly capacitively coupled to the device ground via the metalized surface.

In a second aspect, an antenna apparatus is disclosed. In one embodiment, the antenna apparatus includes: at least one radiator element that includes a feed point, and a conductive element coupled to the feed point, a dielectric substrate having a plurality of surfaces and further including at least one radiator element and a metal surface, and a ground plane coupled to a ground of a host device, where the metal surface is configured to capacitively couple at least a portion a back cover of the host device to the ground of the host device.

In one variant, the outer metal surface is coupled to the ground of the host device via one or more galvanic contacts.

In yet another variant the metal surface is configured so that performance of the at least one radiator element is substantially independent of the back cover.

In a third aspect, a method for grounding one or more components of a mobile wireless device is disclosed. In one embodiment, the method includes: metalizing at least an exterior portion of a main body of the mobile wireless device, connecting the metalized exterior portion to a ground of the mobile wireless device using at least one galvanic contact, and capacitive coupling at least a portion of a back cover of the mobile wireless device to the metalized exterior portion, the capacitive coupling configured to ground the metalized exterior portion to the ground of the mobile wireless device.

In one variant, the method further includes forming at least one galvanic contact by metalizing an interior portion of the main body.

In another variant, the capacitive coupling is configured to reduce a number of galvanic contacts otherwise required to achieve a performance of grounding of the back cover to the ground of the mobile wireless device.

In a fourth aspect, a method of manufacturing an antenna apparatus is disclosed.

Further features of the present disclosure, its nature and various advantages will be more apparent from the accompanying drawings and the following detailed description.

### BRIEF DESCRIPTION OF THE DRAWINGS

The features, objectives, and advantages of the disclosure will become more apparent from the detailed description set forth below when taken in conjunction with the drawings, wherein:

FIG. 1A is a perspective partially exploded view of an exemplary embodiment of a mobile device configured in accordance with the present disclosure.

FIG. 1B is a perspective view of the exemplary mobile device of FIG. 1A.

FIG. 2 is a cross-sectional view of the mobile device of FIGS. 1A-1B, taken along line 2-2.

FIG. 3 is an isometric view of an internal surface of a middle deck of the mobile device FIGS. 1A-2.

FIG. 4 is a logical flow diagram illustrating one embodiment of a method of manufacturing the grounding apparatus according to the present disclosure.

FIG. 5 is a graph of measured free-space efficiency (percentage) as a function of frequency, measured with main and division antenna components of the exemplary embodiment of the mobile device, comparing performance in a low band (i.e. 900 MHz and LTE-band 17) of a galvanic connected metal back plate versus a capacitive coupled back cover.

FIG. 6 is a graph of measured free-space efficiency (percentage) as a function of frequency, measured with main and divisional antenna components of the exemplary embodiment of the mobile device, comparing performance in a high band of a galvanic connected metal back plate versus a capacitive coupled back cover.

FIG. 7 is a graph of measured free-space efficiency (percentage) as a function of frequency, measured with Global Positioning System (GPS) antenna components of the exemplary embodiment of the mobile device, demonstrating comparable performance a galvanic connected metal back plate versus a capacitive coupled back cover.

All Figures disclosed herein are © Copyright 2013 Pulse Finland Oy. All rights reserved.

### DETAILED DESCRIPTION

Reference is now made to the drawings, wherein like numerals refer to like parts throughout.

As used herein, the terms “antenna,” “antenna system,” “antenna assembly”, and “multi-band antenna” refer without limitation to any system that incorporates a single element, multiple elements, or one or more arrays of elements that receive/transmit and/or propagate one or more frequency bands of electromagnetic radiation. The radiation may be of numerous types, e.g., microwave, millimeter wave, radio frequency, digital modulated, analog, analog/digital encoded, digitally encoded millimeter wave energy, or the like. The energy may be transmitted from location to another location, using, or more repeater links, and one or more locations may be mobile, stationary, or fixed to a location on earth such as a base station.

As used herein, the terms “board” and “substrate” refer generally and without limitation to any substantially planar or curved surface or component upon which other components can be disposed. For example, a substrate may comprise a single or multi-layered printed circuit board (e.g., FR4), a semi-conductive die or wafer, or even a surface of a housing or other device component, and may be substantially rigid or alternatively at least somewhat flexible.

The terms “frequency range”, “frequency band”, and “frequency domain” refer without limitation to any frequency range for communicating signals. Such signals may be communicated pursuant to one or more standards or wireless air interfaces.

The terms “near field communication” and “NFC” refer without limitation to a short-range high frequency wireless communication technology which enables the exchange of data between devices over short distances such as described by ISO/IEC 18092/ECMA-340 standard and/or ISO/ELEC 14443 proximity-card standard. As used herein, the terms “portable device”, “mobile device”, “client device”, “portable device”, and “end user device” include, but are not limited to, personal computers (PCs) and minicomputers, whether desktop, laptop, or otherwise, set-top boxes, personal digital assistants (PDAs), handheld computers, personal communicators, tablet computers, portable navigation aids, J2ME equipped devices, cellular telephones, smartphones, personal integrated communication or entertainment devices, or literally any other device capable of interchanging data with a network or another device.

Furthermore, as used herein, the terms “radiator,” “radiating plane,” and “radiating element” refer without limitation to an element that can function as part of a system that receives and/or transmits radio-frequency electromagnetic radiation; e.g., an antenna.

The terms “RF feed,” “feed,” “feed conductor,” and “feed network” refer without limitation to any energy conductor and coupling element(s) that can transfer energy, transform impedance, enhance performance characteristics, and conform impedance properties between an incoming/outgoing RF energy signals to that of one or more connective elements, such as for example a radiator.

As used herein, the terms “top”, “bottom”, “side”, “up”, “down”, “left”, “right”, and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

As used herein, the term “wireless” means any wireless signal, data, communication, or other interface including without limitation Wi-Fi, Bluetooth, 3G (e.g., 3GPP, 3GPP2, and UMTS), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, Long Term Evolution (LTE) or LTE-Advanced (LTE-A), analog cellular, CDPD, satellite systems such as GPS, millimeter wave or microwave systems, optical, acoustic, and infrared (i.e., IrDA).

Furthermore, while primarily discussed in terms of manufacturing using methods such as laser direct structuring (LDS), it is recognized that the antenna embodiments discussed herein may be readily manufactured from other known methods including, for example: (1) flexible substrates; (2) sheet metal fabrication techniques; (3) fluid or vapor deposition; (4) “2-shot” molding; (5) pad printing; and (6) print deposition can be used to manufacture the various components as applicable, such techniques and structures being readily determined by those of ordinary skill when given the present disclosure.

### Overview

In one salient aspect, the present disclosure provides improved grounding apparatus, and methods of manufacturing and using the same. In one embodiment, an outer metallized surface of a mobile device is configured to capacitively couple a metal back cover to the device ground. Specifically, in one implementation, an exterior surface of the mobile device is metalized and coupled to the device ground via galvanic contacts. The exterior metalized surface is configured to be capacitively coupled a metal back cover of a mobile device to the device ground when the back cover is installed on the mobile device. By capacitively coupling the back cover to the device ground via the exterior metalized surface, the need to otherwise ground the back cover through the use of galvanic contacts is obviated, thereby reducing the number of components needed. Furthermore, as the exterior metalized surface is configured to implement capacitive coupling to ground via galvanic contacts (as compared to galvanic contacts connected directly to the back cover), the placement of galvanic contacts connected to the exterior metalized surface may be moved to more suitable locations that would have otherwise been dictated by physical constraints between the mobile device and the back cover.

In addition, as no direct physical contact between the back cover and the device ground is necessary, reliability of the grounding is improved, since the back cover grounding is not subject to failures such as failure of metal-to-metal joint bonding of the galvanic contacts between the back cover and the mobile device ground.

In one implementation, the exterior metalized surface is configured to achieve antenna performance substantially independent of the material composition of the back cover of the mobile device. Accordingly, one salient advantage provided by the exemplary embodiments of the grounding apparatus is the provision of enhanced design freedom of the back cover, without effecting antenna (electrical) performance or that of the host mobile device.

### Detailed Description of Exemplary Embodiments

Detailed descriptions of the various embodiments and variants of the apparatus and methods of the present disclosure are now provided. While primarily discussed in the context of mobile devices, the various apparatus and methodologies discussed herein are not so limited. In fact, many of the apparatus and methodologies described herein are useful in any number of complex antennas, whether associated with mobile or fixed devices that can benefit from the grounding methodologies and apparatus described herein.

### Exemplary Mobile Device Configuration

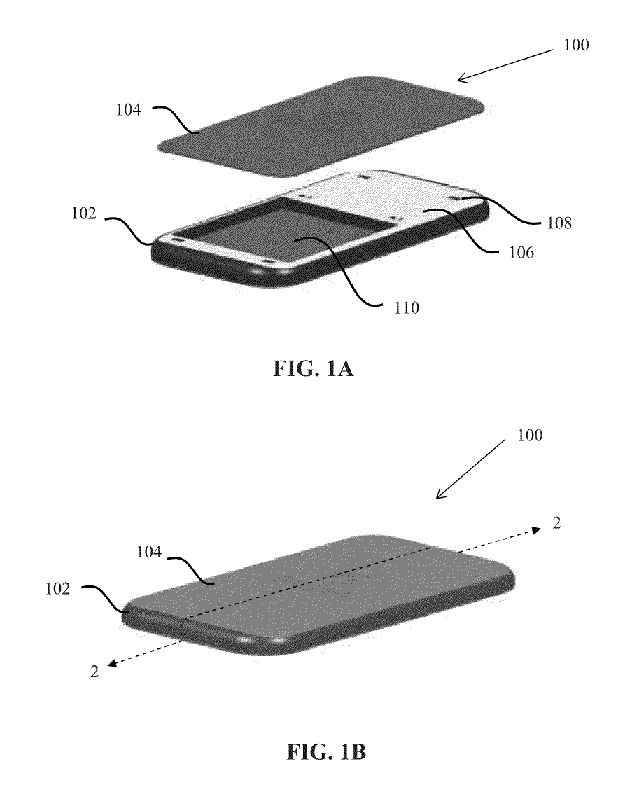

Referring now to FIG. 1, an exemplary embodiment of a mobile device 100 configured in accordance with the principles of the present disclosure is shown and described. In this embodiment, the mobile device 100 comprises a device body 102 and a back cover 104. The device body 102 comprises an outer metallized surface 106, and is configured to house the internal components of the mobile device 100, such as for example a chassis, one or more printed circuit boards, antenna assemblies, display components, one or more user interfaces, etc.

In one implementation, the outer metalized surface 106 is formed on the device body 102 using a laser direct structuring (LDS) process. Specifically, advances in manufacturing processes have enabled the construction of metallized structures directly onto the surface of a specialized material (e.g., a thermoplastic material that is doped with a metal additive). The doped metal additive is activated by means of a laser, which enables the construction of metallized component features onto more complex three-dimensional geometries. A laser is then used to activate areas of the (thermoplastic) material that are to be subsequently plated. An electrolytic copper bath followed by successive additive layers (such as nickel or gold) can then be added if needed to complete the construction of the metallized structures. LDS processes are well known to those of ordinary skill in the art, and accordingly are not described further herein.

In another implementation deposition of the conductive fluid for the outer metalized surface 106 is accomplished using the techniques described in co-owned and co-pending U.S. patent application Ser. No. 13/782,993 filed Mar. 1, 2013 and entitled “DEPOSITION ANTENNA APPARATUS AND METHODS”, incorporated herein by reference in its entirety, although it will be appreciated that other approaches may be used in place of or in conjunction with the foregoing.

The device body 102 is further configured with a plurality of galvanic grounding elements 108 which are in electrical connection with the outer metallized surface 106. The device body 102 further comprises a cavity 110 to contain at least a battery component (not shown). However, any number of physical features may be formed into the device body 102 depending on device application as would be readily apparent to a person of skill. In one implementation, the back cover 104 is composed at least partly of metal, which is grounded to the outer metallized surface 106 via capacitive coupling. The outer metallized surface 106 coupled to the back cover 104 defines the top lip of the electrical “box” of the mobile device 100 useful in maintaining consistent antenna performance of the mobile device 100.

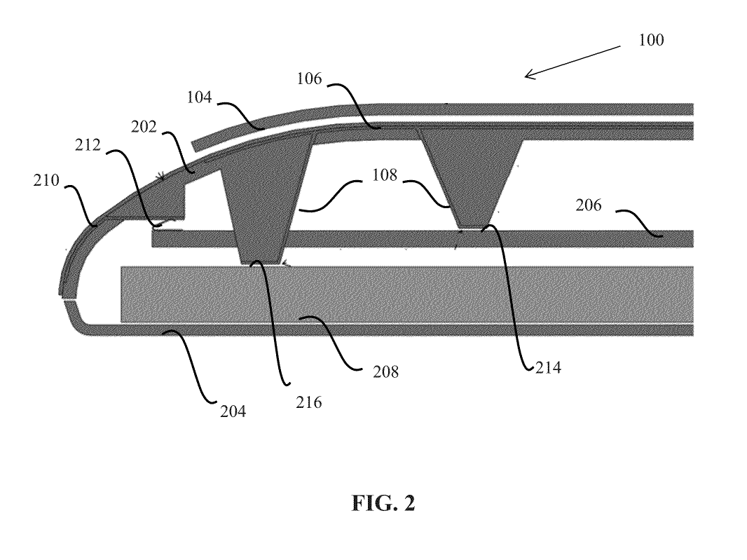

Referring now to FIG. 2, a cross-sectional view of mobile device 100 of FIG. 1 is shown and described. In one embodiment, the device body 102 comprises a middle deck 202 and a front body portion 204. The middle deck 202 and front body portion 204 are fabricated from any suitable dielectric material (e.g., plastic, glass, zirconia) and are attached to one another by any of a variety of suitable means, such as e.g., adhesive, press-fit, heat staking, snap-in with support of additional retaining members (not shown), or the like. Alternatively, the middle deck 202 and/or the front body portion 204 may be fabricated from a non-conductive film, or non-conductive paint bonded onto one or more exterior surfaces, or any combination of the foregoing.

Within device body 102, a main board 206 and display component 208 are contained, although numbers other types of components may be housed with the device body 102, as would be recognizable by a person of skill. In one variant, the display component 208 comprises a display-only device configured only to display content or data. In another embodiment, the display component 208 is a touch screen display (e.g., capacitive, resistive, or other technology) that allows for user input into the device via the display component 208. The display component 208 may comprise, for example, a liquid crystal display (LCD), light-emitting diode (LED) display, organic light emitting diode (OLED) display, or TFT-based device. It is appreciated by those skilled in the art that methodologies of the present disclosure are equally applicable to any future display technology, provided the display module is generally mechanically compatible with configurations such as those described in FIG. 1-FIG. 2.

In one embodiment, the middle deck 202 comprises one or more antenna elements 210. The main board 206 comprises a printed circuit board containing various components of the mobile device 100. Additionally, the one or more antenna elements 210 and main board 206 are configured to be in electrical contact via one or more antenna contacts 212. In one variant, the one or more antenna elements 210 are affixed to the mobile device 100 via a conductive “sponge” (i.e., conductive foam material) at the ground coupling point, and to the feed point via antenna contact 212. In another variant, both above connections are effected via solder joints. In yet another variant, both connections are effected via a conductive sponge. Other electrical coupling methods are useable with embodiments of the present disclosure including, but not limited to, c-clips, pogo pins, heat staking, etc. Additionally, a suitable adhesive or mechanical retaining means (e.g., snap fit) may be used if desired to affix an antenna element 210 to the mobile device 100 housing.

In one embodiment, each antenna element 210 is configured to operate in a separate frequency band (e.g., one antenna element 210 in a lower frequency band, and one antenna element 210 in an upper frequency band), although it will be appreciated that less or more and/or different bands may be formed based on varying configurations and/or numbers of antenna elements 210.

In one implementation, the lower frequency band (i.e., that associated with one of the two radiating elements operating at lower frequency) comprises a sub-GHz Global System for Mobile Communications (GSM) band (e.g., GSM710, GSM750, GSM850, GSM810, GSM900), while the higher band comprises a GSM1900, GSM1800, or PCS-1900 frequency band (e.g., 1.8 or 1.9 GHz).

In another implementation, the low or high band comprises the Global Positioning System (GPS) frequency band, and the antenna is used for receiving GPS position signals for decoding by e.g., an internal GPS receiver. In one variant, a single upper band antenna assembly operates in both the GPS and the Bluetooth frequency bands.

In another variant, the high-band comprises a Wi-Fi (IEEE Std. 802.11) or Bluetooth frequency band (e.g., approximately 2.4 GHz), and the lower band comprises GSM1900, GSM1800, or PCS1900 frequency band.

In yet another variant, two or more antennas elements, configured in accordance with the principles of the present disclosure, operate in the same frequency band thus providing, inter alia, diversity for Multiple In Multiple Out (MIMO) or for Multiple In Single Out (MISO) applications.

In another implementation, one of the frequency bands comprises a frequency band suitable for Near Field Communications applications, e.g., ISM 13.56 MHz band.

Other variants are configured the one or more antenna elements to cover LTE/LTE-A (e.g., 698 MHz-740 MHz, 900 MHz, 1800 MHz, and 2.5 GHz-2.6 GHz), WWAN (e.g., 824 MHz-960 MHz, and 1710 MHz-2170 MHz), and/or WiMAX (2.3, and 2.5 GHz) frequency bands.

In one embodiment, a portion of the middle deck 202 comprises the metalized outer surface 106. The middle deck 202 further comprises galvanic grounding elements 108, at least a portion of which are in electrical connection with the outer metalized surface 106. In one implementation, the galvanic grounding elements 108 comprise metallized portions of the middle deck 202. The metalized portions of the galvanic grounding elements 108 may be achieved via an LDS or similar plating process, via deposition (e.g., conductive fluid deposition as previously referenced), or other. The size and shape of the underlying structures of the galvanic grounding elements 108 may be configured based on a specific implementation so that the galvanic grounding elements 108 form contact with internal structures and components of the mobile device 100.

In another implementation, the galvanic grounding elements 108 are of separate construction from the middle deck 202. For example, the galvanic grounding elements 108 may comprise plated screw towers to ground the middle deck 202 to various components of the mobile device 100.

The galvanic grounding elements 108 are connected to various grounding contacts of various components housed within device body 102, such as grounding contact pads 214,216 on the main board 206 and/or the display component 208.

In one embodiment, the back cover 104 is at least partly comprised of a metal. The metalized outer surface 106, in conjunction with the galvanic grounding elements 108, are configured to capacitively couple with at least a portion of the metal portion of the back cover 104 in order to ground the back cover 104. As the metal portions of the back cover 104 are coupled to the same ground of the metalized outer surface, the effect of the capacitively coupled metal portions impact on antenna performance can be made negligible in comparison to metalized outer surface 106. The amount of capacitive coupling between the back cover 104 and the outer metalized surface 106 is controllable by one or more of the size of the metal portion of the back cover 104, the size of the outer metalized surface 106, the distance between the back cover 104 and the outer metalized surface 106, and the dielectric material separating the metal portions of the back cover 104 and outer metalized surface 106 (such as non-conductive paint, air, etc.), or any combination thereof as would be recognizable by a person of ordinary skill. Salient advantages of a back cover 104 comprised of metal are improved strength of the mobile device 100 in addition to providing enhanced aesthetics. In one implementation, the surface area size of the metalized outer surface and the back cover 104 is substantially the same. One salient advantage of the capacitive coupling of the back cover 104 to ground is obviation of use of galvanic contacts to otherwise ground the back cover 104. Thus, reliability of the ground is increased due to a not requiring a direct physical connection to ground. In addition, reducing the number of galvanic contacts reduces manufacturing cost, and the amount of board space needed on main board or within the mobile device 100. Furthermore, as the galvanic grounding elements 108 are in electrical connection with the outer metallized surface 106, the galvanic grounding elements 108 may be physically located relatively freely with respect to the physical configuration of the back cover 104, which would otherwise be limited by physical constraints of grounding the back cover 104 physically directly to the mobile device 100. Thus, placement of the galvanic grounding elements 108 may be moved to more suitable locations given other design constraints such as, for example, main board size, internal component placement design, etc. For example, the galvanic grounding elements 108 may be moved to locations suitable for defining the electrical “box” of the mobile device 100, such as being located at the corner(s) and/or side edge(s). However, the galvanic grounding elements 108 may be located at a middle portion of the mobile device 100.

In one implementation, the back cover 104 is solely grounded via capacitive coupling with the outer metallized surface 106. In another variant, the back cover 104 is grounded through both the use of capacitively coupling with the outer metallized surface 106, and one or more galvanic contacts in direct physical connection with the back cover 104 and the device ground. Thus, the use of the capacitive coupling can be used to reduce the number of galvanic contacts of the back cover which may have otherwise been necessary to achieve similar performance, thereby reducing component cost while improving design freedom with regards to placement of the one or more galvanic contacts.

In one implementation, the metalized outer surface 106 is configured with a metallized surface that improves antenna performance, even in the instances where the back cover material has poor conductivity. Thus, the antenna performance, such as the antenna's resonance frequency, is not dependent on the back cover 104 being attached or removed from mobile device 100 thereby improving stability of the antenna performance in view of various back cover configurations. Accordingly, the back cover 104 may be constructed out of a variety of materials such as, for example, stainless steel, gold, aluminum, plastic, leather, etc., affording great design freedom. In one implementation, the back cover 104 can be configured to provide wireless charging to the mobile device 100 such as by the use of, for example, inductive charging technology with a respective charging apparatus.

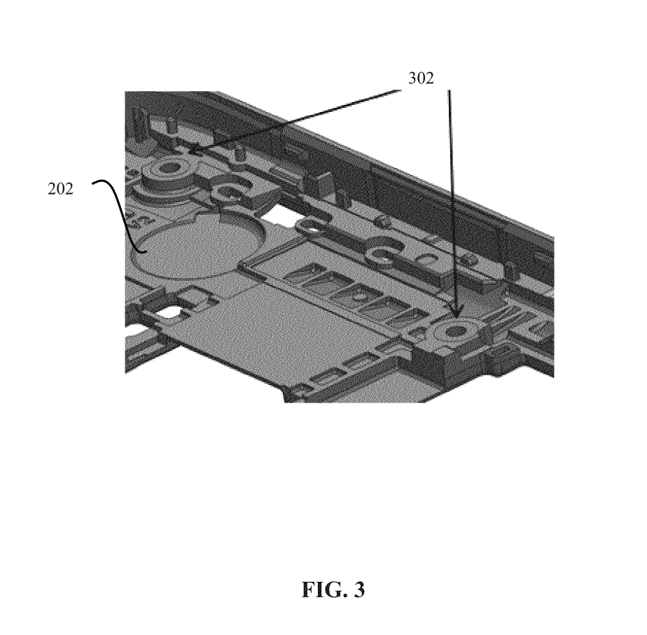

FIG. 3 illustrates an internal surface of one embodiment of the middle deck 202. The exemplary galvanic grounding elements 108 of FIG. 3 are configured with metallized vias 302 running from the outer metallized surface to form the electrical interface with respective grounding contacts of components within the mobile device 100. However, the electrical interface may be achieved with a variety of methods, such as c-clips, screws, pins, etc.

While the various exemplary embodiments have been presented with respect to capacitive coupling a back cover 104 to ground of a mobile device 100, the present disclosure is not so limited. The present disclosure is equally applicable to capacitive grounding of any portions of the mobile device 100, including other exterior surfaces of the mobile devices 100, in addition to internal components of the mobile device 100. This approach benefits from replacing at least a portion of the galvanic contacts with the capacitive coupled ground, as would be recognized by a person of ordinary skill in the art.

### Exemplary Method of Manufacture

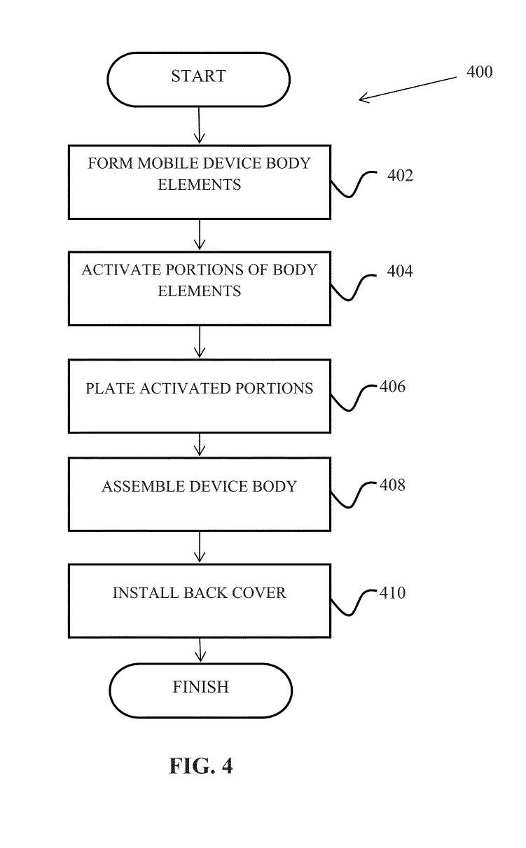

Referring now to FIG. 4, is a logical flow diagram illustrating one embodiment of a method of manufacturing the mobile device of the present disclosure is shown. While the embodiment of FIG. 4 is described in the exemplary context of mobile device 100 of FIGS. 1-3, it will be appreciated that the method may be readily adapted by those of ordinary skill, when given the present disclosure, to other configurations and embodiments. For example, in the case that a flowable conductive ink or other deposition methodology is used to dispose the metalized portions (e.g., outer metallized surface) of the apparatus, steps necessary (or obviated) for such deposition process can be readily substituted, added, or removed from the illustrated method.

As illustrated, the method 400 includes forming the mobile device body elements (e.g., front portion 204, middle deck 202, and back cover 104) of the mobile device body via a molding or other process per step 402. In one embodiment, the middle deck 202 is formed from a specially selected polymer capable of supporting an LDS process (e.g., which is doped and which can be subsequently laser activated for LDS element formation). In one implementation, the middle deck 202 is formed with structures to be used to form galvanic grounding elements 108.

Next, per step 404, the various portions of the mobile device body elements are activated, such as via laser energy, in preparation for metallic layer deposition via LDS.

Then, per step 406, the activated portions are “plated” via the LDS process, so as to form any or all of the outer metallized surface 106 and the galvanic grounding elements 108, as dictated by the design.

Per step 408, the device body 102 is assembled. In one embodiment, the device body 102 is assembled by connecting the middle deck 202 and front body portion 204 along with inserting any internal component(s) of the mobile device 100 (e.g. main board 204, display component 206, fasteners, wires, etc.).

Lastly, the back cover 204 is installed, as well as any other remaining components (e.g., battery component) onto the device body 102 by affixing back cover 104 per step 410. The mobile device 100 may then be tested, labeled, and/or otherwise prepared if/as desired.

### Performance

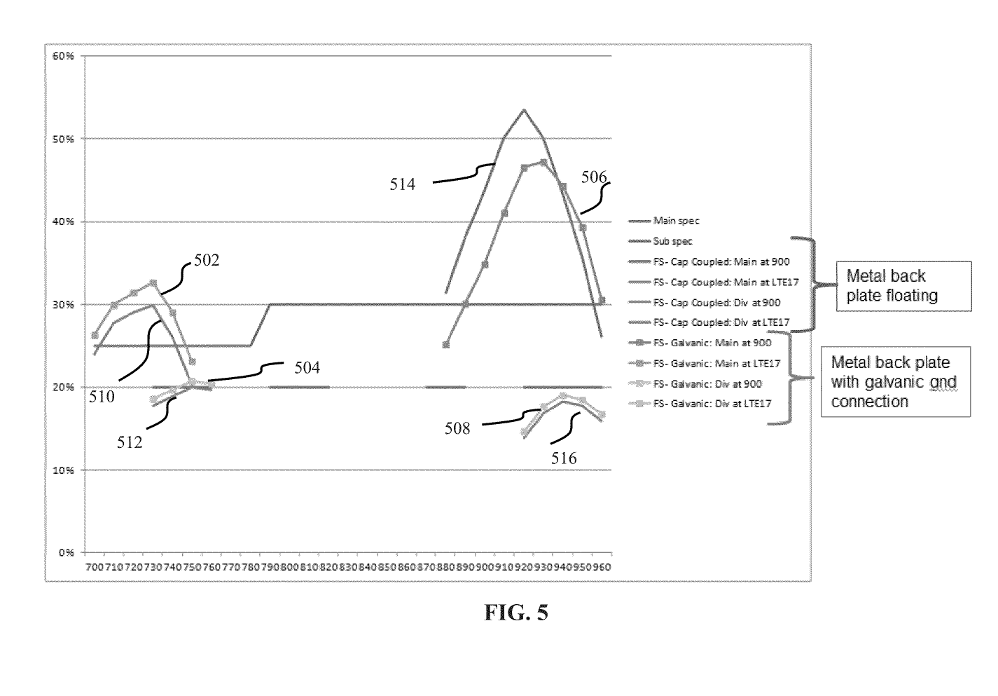

Referring now to FIGS. 5 through 7, performance results obtained during testing by the Assignee hereof of an exemplary mobile device constructed according to the present disclosure are presented.

FIG. 5 presents data regarding measured free-space efficiency (percentage) as a function of frequency, measured with main and division antenna components of the mobile device comparing performance in a low band (i.e. 900 MHz and LTE-band 17) of a galvanic connected metal back plate versus a capacitive coupled back cover 104 configured in accordance with the present disclosure.

$$AntennaEfficiency = ( \frac{Radiated Power}{Input Power} ) \times 100 \% \qquad Eqn . ( 1 )$$

Exemplary data for the lower frequency bands show comparable performance of the main and divisional antenna components of the mobile device in the low band between the galvanic connected metal back plate (502, 504, 506, 508) and the capacitive coupled back cover 104 (510, 512, 514, 516).

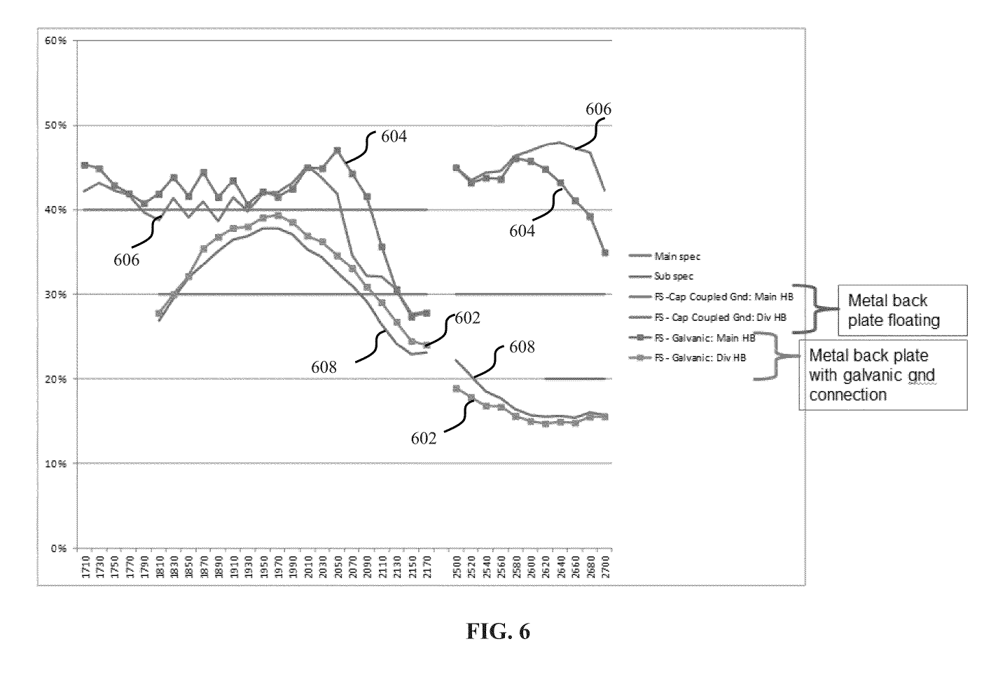

FIG. 6 presents data regarding measured free-space efficiency (percentage) as a function of frequency, measured with main and divisional antenna components of the mobile device comparing performance in a high band of a galvanic connected metal back plate versus a capacitive coupled back cover 104 configured in accordance with the present disclosure. As shown by FIG. 6, performance of the galvanic connected back plate (602, 604) is comparable to the performance of the capacitive coupled back cover (606, 608).

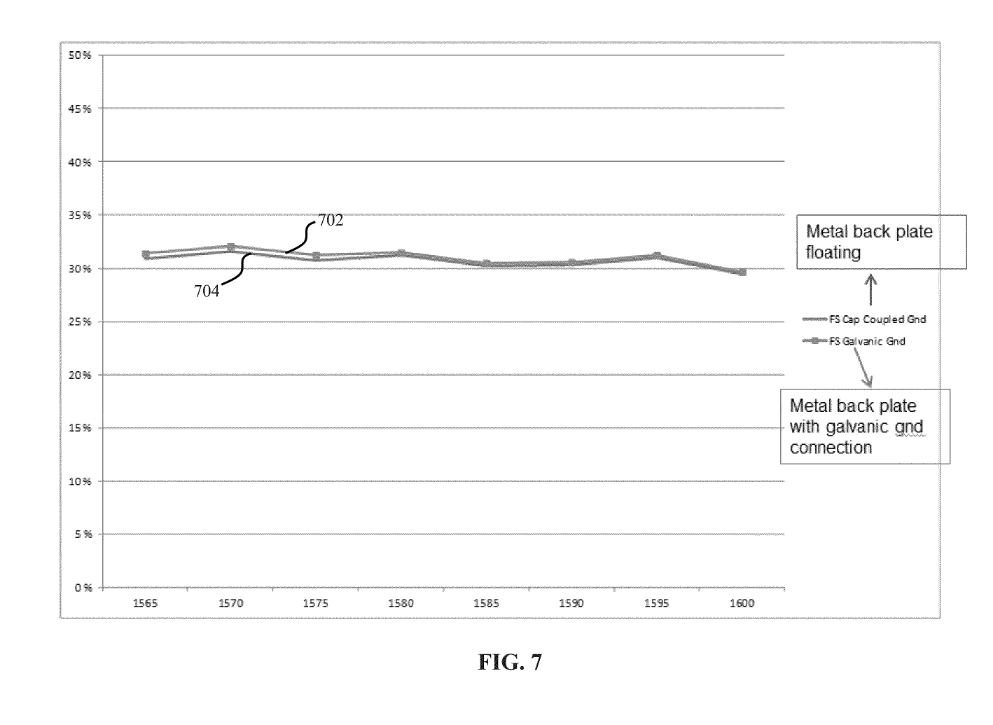

FIG. 7 presents data regarding measured free-space efficiency (percentage) as a function of frequency, measured with Global Positioning System (GPS) antenna components of the mobile device demonstrating comparable performance a galvanic connected metal back plate (702) versus a capacitive coupled back cover (704) configured in accordance with the present disclosure.

It will be recognized that while certain aspects of the disclosure are described in terms of a specific sequence of steps of a method, these descriptions are only illustrative of the broader methods of the present disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure as discussed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A mobile wireless device, comprising:
one or more antenna elements;
a main body portion, said main body portion comprising at least a metalized surface; and
a back cover portion, said back cover portion at least partly capacitively coupled to a device ground of said mobile wireless device.

2. The mobile wireless device of claim 1, wherein said at least metalized surface is connected to said device ground via one or more galvanic contacts.

3. The mobile wireless device of claim 2, wherein said back cover portion is at least partly capacitively coupled to said device ground via said metalized surface.

4. The mobile wireless device of claim 3, wherein the main body portion comprises a middle portion, said middle portion comprising at least a portion of said one or more galvanic contacts.

5. The mobile wireless device of claim 2, wherein said capacitive coupling to said device ground is configured to reduce a number of galvanic contacts necessary to achieve substantially similar performance of at least one or said one or more antenna elements.

6. The mobile wireless device of claim 5, wherein said performance comprises a resonance frequency of said one or more antenna elements.

7. The mobile wireless device of claim 1, wherein performance of at least one of said one or more antenna elements is substantially independent from placement of said back cover portion on said mobile wireless device.

8. The mobile wireless device of claim 7, wherein said performance comprises a resonance frequency of said one or more antenna elements.

9. The mobile wireless device of claim 1, wherein performance of at least one of said one or more antenna elements is substantially independent from a construction material of said back cover portion.

10. The mobile wireless device of claim 1, wherein said at least metalized surface is formed on said main body portion using a laser direct structuring (LDS) process.

11. An antenna apparatus, comprising;
at least one radiator element comprising:
a feed point; and
a conductive element coupled to said feed point;
a dielectric substrate having a plurality of surfaces, said dielectric substrate comprising said least one radiator element and a metal surface; and
a ground plane coupled to a ground of a host device;
wherein said metal surface is configured to capacitively couple at least a portion a back cover of said host device to said ground of said host device.

12. The antenna apparatus of claim 11, wherein said outer metal surface is coupled to said ground of said host device via one or more galvanic contacts.

13. The antenna apparatus of claim 12, wherein said dielectric substrate further comprises at least a portion of said one or more galvanic contacts.

14. The antenna apparatus of claim 11, wherein said metal surface is configured so that performance of said at least one radiator element is substantially independent of said back cover.

15. The antenna apparatus of claim 14, wherein said performance comprises a resonance frequency of said at least one radiator element.

16. The antenna apparatus of claim 11, wherein said capacitively coupling is configured to reduce a number of galvanic contacts necessary to achieve substantially similar performance of said at least one radiator element.

17. The antenna apparatus of claim 16, wherein said performance comprises a resonance frequency of said at least one radiator element.

18. A method for grounding one or more components of a mobile wireless device, said method comprising:
metalizing at least an exterior portion of a main body of said mobile wireless device;
connecting said metalized exterior portion to a ground of said mobile wireless device using at least one galvanic contact; and
capacitive coupling at least a portion of a back cover of said mobile wireless device to said metalized exterior portion, said capacitive coupling configured to ground said metalized exterior portion to said ground of said mobile wireless device.

19. The method of claim 18, further comprising forming said at least one galvanic contact by metalizing an interior portion of said main body.

20. The method of claim 18, wherein said capacitive coupling is configured to reduce a number of galvanic contacts otherwise required to achieve a performance of grounding of said back cover to said ground of said mobile wireless device.
